(19) United States
(12) Patent Application Publication
(10) Pub. No.: US 2015/0241977 A1
(43) Pub. Date: Aug. 27, 2015

(54) DETECTING A COMMAND FROM A COMBINED MOTION

(71) Applicant: LENOVO (Singapore) PTE, LTD., New Tech Park (SG)

(72) Inventors: Rod D. Waltermann, Rougemont, NC (US); Mark Evan Cohen, Cary, NC (US)

(73) Assignee: LENOVO (Singapore) PTE, LTD., New Tech Park (SG)

(21) Appl. No.: 14/186,605

(22) Filed: Feb. 21, 2014

(51) Int. Cl. G06F 3/01; G06T 7/00; G06T 7/20; G06F 3/00

(52) U.S. Cl. CPC G06F 3/017; G06F 3/005; G06T 7/0042; G06T 7/2033; G06T 2207/30196; G06T 2207/20221

(57) ABSTRACT

For detecting a command from a combined motion, a low precision lens directs light between a high precision boundary angle and the low precision boundary angle to a camera to form a low precision image. A high precision lens directs light within the high precision boundary angle to the camera to form a high precision image. A memory stores code executable by a processor. The code combines a low precision motion of the low precision image with a high precision motion of the high precision image to form a combined motion. The code further detects a command from the combined motion.

### BACKGROUND

1. Field

The subject matter disclosed herein relates to detecting a command and more particularly relates to detecting a command from a combined motion.

2. Description of the Related Art

A computer may include a camera. The camera may detect a motion such as gestures that may be interpreted as commands.

### BRIEF SUMMARY

An apparatus for detecting a command from a combined motion is disclosed. The apparatus includes a camera, a low precision lens, a high precision lens, a processor, a communication channel, and a memory. The low precision lens directs light between a high precision boundary angle and the low precision boundary angle to the camera to form a low precision image. The high precision lens directs light within the high precision boundary angle to the camera to form a high precision image. The memory stores code executable by the processor. The code combines a low precision motion of the low precision image with a high precision motion of the high precision image to form a combined motion. The code further detects a command from the combined motion. A method and computer program product also perform the functions of the apparatus.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a front view drawing illustrating one embodiment of a lens system;

FIG. 1B is a front view drawing illustrating one alternate embodiment of a lens system;

FIG. 1C is a front view drawing illustrating one embodiment of a lens system with a multi-faceted lens;

FIG. 1D is a front view drawing illustrating one embodiment of a lens system;

FIG. 2 is a side view drawing illustrating one embodiment of a camera system;

FIG. 3A is a schematic block diagram illustrating one embodiment of object data;

FIG. 3B is a schematic block diagram illustrating one embodiment of view angle data;

FIG. 3C is a schematic block diagram illustrating one embodiment of image data;

FIG. 4 is a schematic block diagram illustrating one embodiment of a computer; and

FIG. 5 is a schematic flow chart diagram illustrating one embodiment of command detection method.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages, including an object oriented programming language such as Java, Smalltalk, C++ or the like and conventional procedural programming languages, such as the “C” programming language or similar programming languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Computers may receive input from the physical world in a variety of ways. Keyboards and pointing devices such as a mouse are often used to provide input to a computer. Computers may also receive audible input and visual input. For example, a camera on a computer may detect the motion of the gesture and detect a command from the gesture.

Unfortunately, the field of view for most cameras is limited. As a result, the user that is using a gesture to direct a computer must be within that narrow field of view for the camera to observe the gesture and the computer to detect the command. However, in some computing environments, particularly environments that support collaborative computing, tabletop displays, wall-mounted displays, or the like, the user may not always be within the narrow field of view of the camera. As a result, the user may be unable to use gesture input in some locations relative to the computer and/or the camera.

While a high precision wide-angle lens may increase the field of view of the camera, wide-angle lenses are often expensive, and may be prohibitively expensive for use with a computer. In addition, lower precision wide-angle lenses may be unsuitable for other camera operations, such as videoconferencing and/or video communications. The embodiments described herein employ a low precision lens with a wide field of view along with a high precision lens as will be described hereafter.

The low precision lens may capture motion over a wide field of view, increasing the area from which the user may communicate gesture commands to the computer. The high precision lens may support other imaging functions such as videoconferencing. As a result, the embodiments provide a lower-cost camera system that both captures command gestures over a wide field of view while providing a high precision image within a narrower field of view as will be described hereafter.

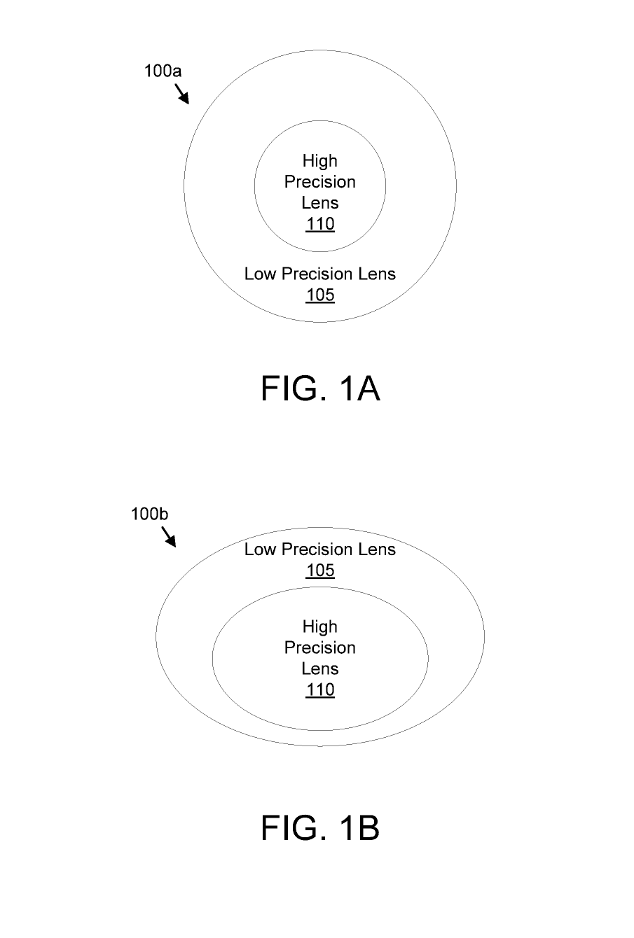

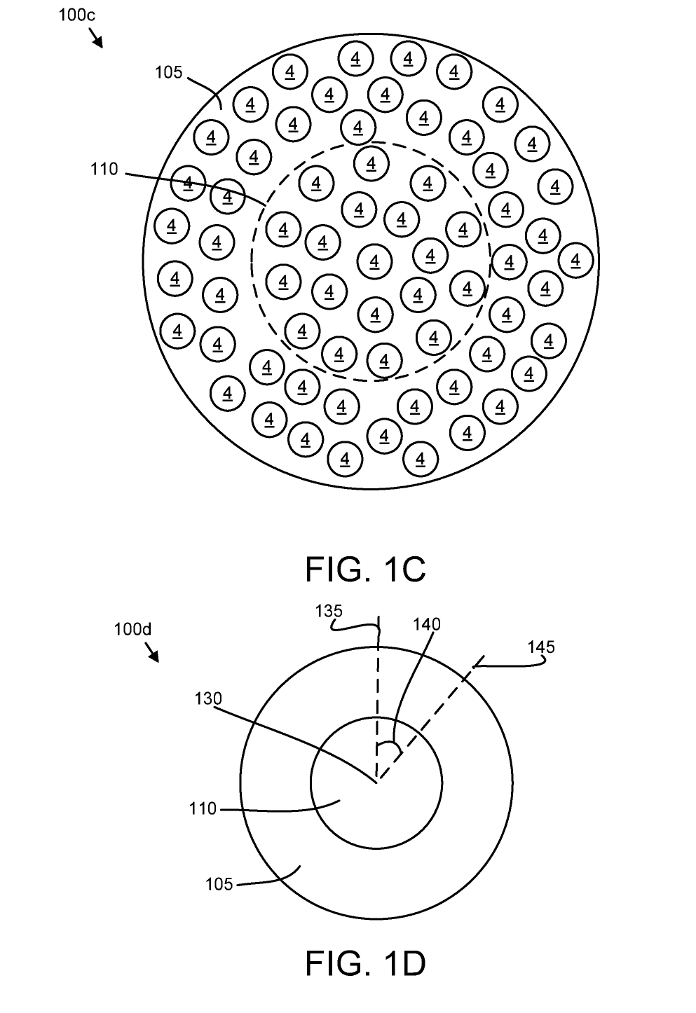

FIG. 1A is a front view drawing illustrating one embodiment of a lens system 100a. The system 100a includes a high precision lens 110 and a low precision lens 105. The high precision lens 110 may be selected from the group consisting of a fresnel lens, a multi-faceted lens, a compound lens, a bifocal lens, and a micro lens. In addition, the low precision lens 105 may be selected from the group consisting of a fresnel lens, a multi-faceted lens, a compound lens, and a micro lens.

In the depicted embodiment, the high precision lens 110 is embodied within the low precision lens 105. In addition, the high precision lens 110 and the low precision lens 105 may be round lenses. In the depicted embodiment, the high precision lens 110 and the low precision lens 105 share a common central vector as will be shown hereafter.

The lens system 100a may be a compound lens. Alternatively, the lens system 100a may be a single optical element with a high precision lens portion and a low precision lens portion.

FIG. 1B is a front view drawing illustrating one alternate embodiment of a lens system 100b. In the depicted embodiment, the high precision lens 110 and the low precision lens 105 have an oval shape. In addition, a central vector of the high precision lens 110 is offset from the central vector of the low precision lens 105. The embodiments may be practiced with multiple shapes of the high precision lens 110 in the low precision lens 105, multiple dispositions of the high precision lens 110 relative to the low precision lens 105. The embodiments disclosed herein are in no way limiting.

FIG. 1C is a front view drawing illustrating one embodiment of a lens system 100c with a multi-faceted lens. The system 100c includes a plurality of facets 4. The facets 4 are organized into one of the high precision lens 110 and the low precision lens 105. Each facet 4 may independently focus light along a specified path.

FIG. 1D is a front view drawing illustrating one embodiment of a lens system 100d. In the depicted embodiment, the high resolution lens 110 and the low resolution lens 105 share a common central vector 130 orthogonal to the plane of the drawing. A reference vector 135 is shown orthogonal to the central vector 130. An object and/or pixel may be disposed along an object vector 145 at an object view angle 140 relative to the reference vector 135. A view angle for determining a high precision boundary angle as will be described hereafter is also measured from the reference vector 135 as is the object view angle 140.

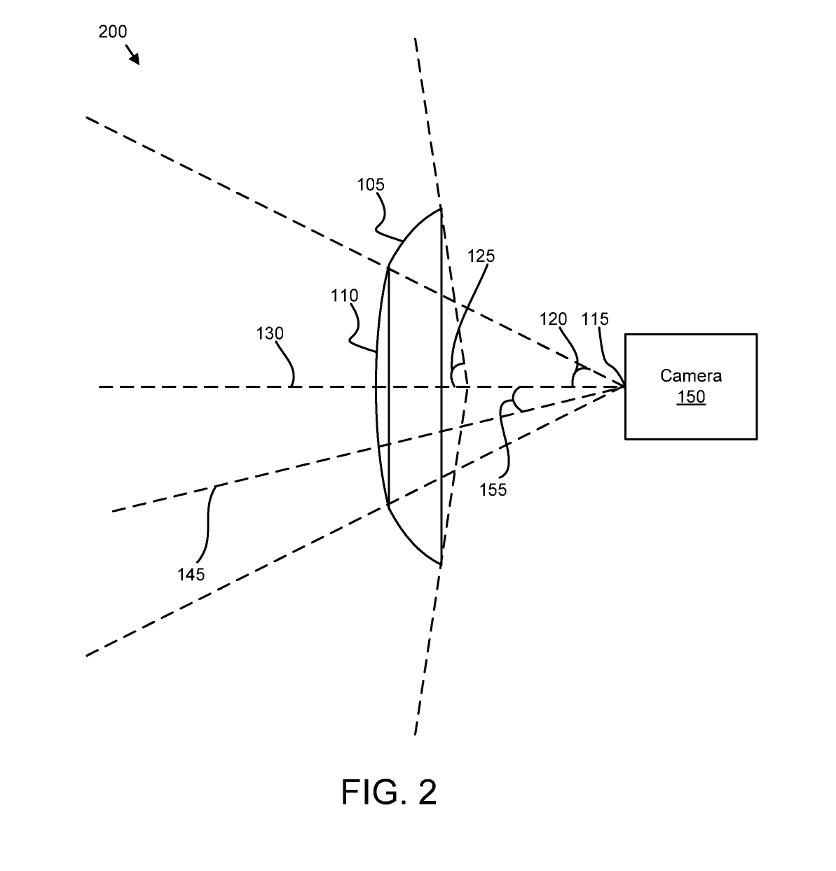

FIG. 2 is a side view drawing illustrating one embodiment of a camera system 200. The camera system 200 may include the lens system 100 and a camera 150. In one embodiment, the camera system 200 is separate from a computer. In the depicted embodiment, the high precision lens 110 of the lens system 100 is embodied within the low precision lens 105. In addition, the high precision lens 110 and the low precision lens 105 share a central vector 130.

In one embodiment, the high precision lens 110 and the low precision lens 105 focus light on a focal point 115 at the camera 150. The camera 150 may be a charge coupled device (CCD) that captures an image. In one embodiment, a lens (not shown) disposed at the focal point 115 focuses light on the CCD. Alternatively, a lens (not shown) disposed near the focal point 115 focuses light on the CCD.

A high precision boundary angle 120 may divide images of the high precision lens 110 from images the low precision lens 105. The high precision lens 110 may direct light within the high precision boundary angle 120 to the camera 150 to form a high precision image. The low precision lens 105 may direct light between the high precision boundary angle 120 and the low precision boundary angle 125 to the camera 150 to form a low precision image. The low precision boundary angle 125 may be an angle in the range of 160 to 180 degrees.

An object may be disposed along the object vector 145 at a center vector angle 155 to the center vector 130. The center vector angle 155 may be measured relative to the center vector 130.

In one embodiment, the high precision lens 110 is a lens of the camera 150. The low precision lens 105 may be disposed to direct light to the high precision lens 110.

In one embodiment, the high precision lens 110 directs light to a first camera 150, and the low precision lens 105 directs light to a second camera 150. The high precision image and the low precision image may be combined digitally.

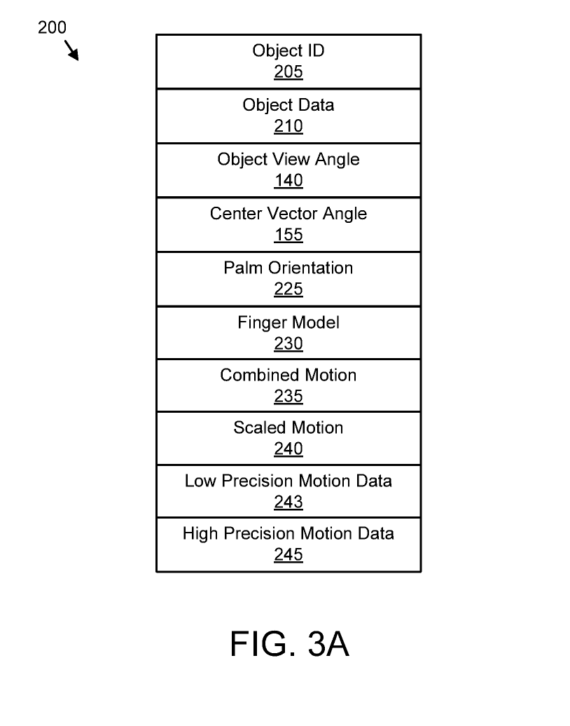

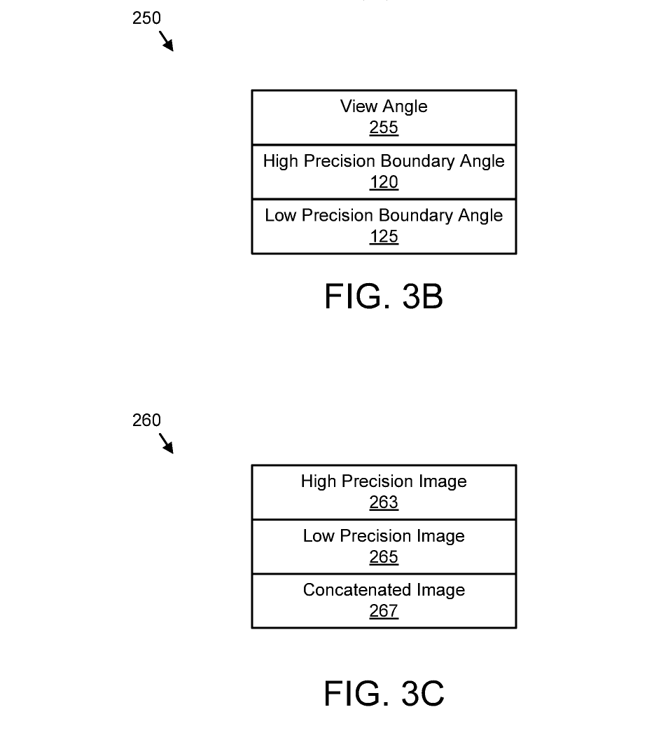

FIG. 3A is a schematic block diagram illustrating one embodiment of object data 200. In one embodiment, the camera 150 captures images of objects. The camera 150 and/or a computer may identify the objects from the images. The objects may be recorded as the object data 200. In the depicted embodiment, the object data 200 includes an object identifier 205, object data 210, the object view angle 140 for the object, the center vector angle 155 for the object, a palm orientation 225, a finger model 230, the combined motion 235, a scaled motion 240, low precision motion data 243, and high precision motion data 245.

The object identifier 205 may uniquely identify the object. The object data 210 may describe the pixels of the object, object boundaries, at least one primitive shape for the object, and identity of the object, or combinations thereof. For example, the object data 210 may include a listing of the pixels representing a user within an image, the boundaries of the user within the image, primitive shapes describing the user, and/or the identity of the user.

The object view angle 140 is the object view angle 140 of FIG. 1D to the object. The center vector angle 155 is the center vector angle 155 of FIG. 2.

In one embodiment, a palm of the user's hand may be identified from an image. The palm orientation 225 may include a spatial location of the palm and/or an orientation of the palm. The orientation of the palm may be relative to the camera 150.

In one embodiment, a finger model 230 of the user's hand may be generated from the image. The finger model 230 may comprise a spatial model of each finger in the user's hand.

The combined motion 235 may combine a low precision motion of a low precision image from the low precision lens 105 with a high precision motion of a high precision image from the high precision lens 110 as will be described hereafter. The scaled motion 240 may be the low precision motion scaled to approximate the high precision motion as will be described hereafter.

The low precision motion data 243 may describe the low precision motion of the low precision image of the object. The high precision motion data 245 may describe the high precision motion of the high precision image of the object. The low precision motion data 243 and high precision motion data 254 may be generated by the identifying the object and determining an angular displacement of the object over time.

FIG. 3B is a schematic block diagram illustrating one embodiment of view angle data set 250. The view angle data set 250 includes a view angle 255, a high precision boundary angle 120, and a low precision boundary angle 125. The view angle 255 is an angle measured from the reference vector 135, similar to the object view angle 140.

The high precision boundary angle 120 and the low precision boundary angle 125 may vary as a function of the view angle 225. The high precision boundary angle 120 in the view angle data set 250 is a high precision boundary angle 120 for the view angle 255. The low precision boundary angle 125 in the view angle data set 250 is a low precision boundary angle 125 for the view angle 255. A plurality of view angle data sets 250 may define the high precision boundary angle 120 and the low precision boundary angle 125 for a lens system 100 where the high precision boundary angle 120 and/or low precision boundary angle 125 are a function of the view angle 255.

FIG. 3C is a schematic block diagram illustrating one embodiment of image data 260. The image data 260 may be stored a video data in a memory. The image data 260 includes the high precision image 263 and the low precision image 265. In one embodiment, the high precision image 263 is captured by first pixels of the camera 150 while the low precision image 263 is captured by second pixels of the camera 150.

In addition, the image data 260 may include a concatenated image 267. The concatenated image 267 may be formed by concatenating the high precision image 263 and the low precision image 265 at the high precision boundary angle 120.

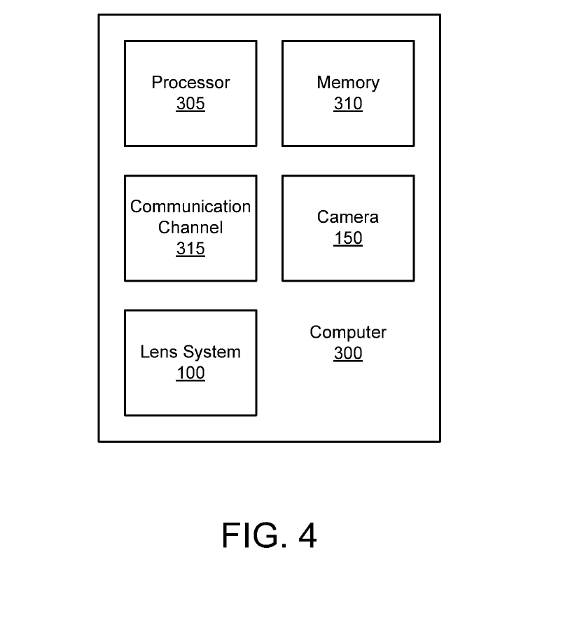

FIG. 4 is a schematic block diagram illustrating one embodiment of a computer 300. The computer 300 may include a processor 305, a memory 310, and a communication channel 315. In one embodiment, the computer 300 includes the camera 150. In addition, the computer 300 may include the lens system 100.

The memory 310 may be a semiconductor storage device, a hard disk drive, an optical storage device, a micromechanical storage device, or combinations thereof. In one embodiment, the memory 310 is a computer readable storage medium. The computer readable storage medium may store code. The processor 305 may execute the code.

The communication channel 315 may include one or more semiconductor devices, connectors, and a wiring harness that couples the camera 150 to the processor 305. In addition, the communication channel 315 may communicate with other devices.

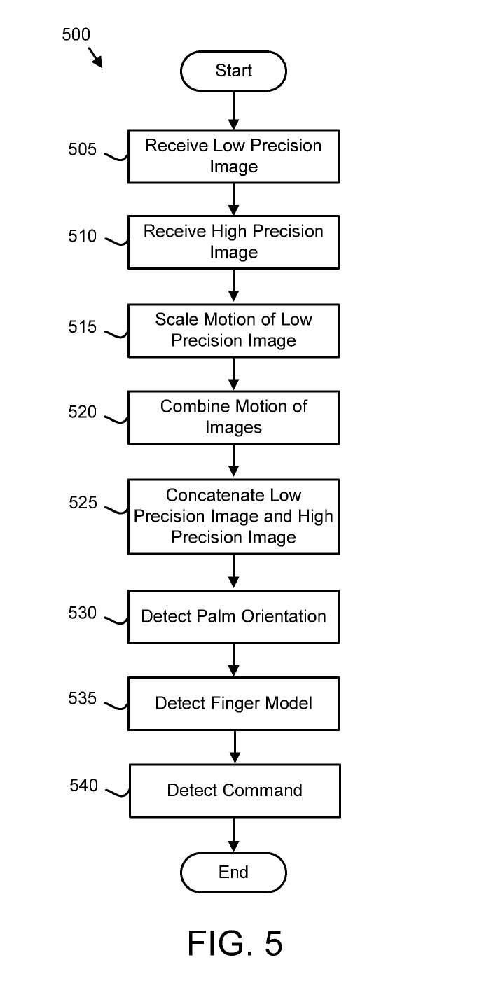

FIG. 5 is a schematic flow chart diagram illustrating one embodiment of command detection method 500. The method 500 may perform the functions of an apparatus such as the computer 300. Portions of the method 500 may be performed by use of a processor. Alternatively, portions of the method 500 may be performed by a program product. The program product may comprise a computer readable storage medium such as the memory 310 that stores code executable by the processor 305 to perform the method 500.

The method 500 starts, and in one embodiment, the camera 150 receives 505 a low precision image 265 from the low precision lens 105. The low precision lens 105 may direct light between the high precision boundary angle 120 and the low precision boundary angle 125 to the camera 150 to form the low precision image 265.

The camera 150 may also receive 510 a high precision image 263 from the high precision lens 110. The high precision lens 110 may direct light within the high precision boundary angle 120 to the camera 150 to form the high precision image 263.

In one embodiment, the processor 305 executing the code scales the low precision motion of the low precision image 265. The low precision motion may be scaled to match the high precision motion of the high precision image. For example, an apparent radial motion of 10 degrees per second by the low precision image may be equivalent to a radial motion of 5 degrees per second by the high precision image.

In one embodiment, the motion of the low precision image is scaled using Equation 1, where LM is a vector of the scaled low precision motion, K is an array of correction constants, and OM is a vector of the observed low precision image motion.

LM=K*OM Equation 1

In one embodiment, the processor 305 executing the code combines 520 the low precision motion of the low precision image 265 with the high precision motion of the high precision image 263 to form a combined motion 235. In a certain embodiment, the scaled low precision motion is combined 520 with a high precision motion. The combined motion CM 235 may be calculated using Equation 2, where HM is a vector of the high precision motion.

CM=OM+HM Equation 2

Alternatively, the combined motion 235 may be calculated using Equation 3.

CM=LM+HM Equation 3

The combined motion 235 may only be a rough approximation of the actual motion of an object. However, the combined motion 235 may be sufficient to identify gestures that are indicative of commands. For example, a right to left sweeping motion of a hand may be a gesture that indicates paging forward in a document. Similarly, a left to right sweeping motion of a hand may be a gesture that indicates paging backward in the document.

In one embodiment, the processor 305 executing the code concatenates 525 the low precision image 265 and the high precision image 263 at the high precision boundary angle 120 to form the concatenated image 267. The low precision image 265 may be adjusted prior to concatenation. For example, the low precision image 265 may comprise a radial distortion. The low precision image 265 may be adjusted to remove the radial distortion.

In one embodiment, the processor 305 executing the code detects 530 the palm orientation 225 for a hand object. The palm orientation 225 may be recorded with the object data 200 for the hand object. In addition, the processor 305 executing the code may detect 535 the finger model 230 for the hand object. The finger model 230 may be recorded with the object data 200 for the hand object.

The processor 305 executing the code may detect 540 a command from the combined motion 235 and the method 500 ends. The code may adjust the low precision motion to be equivalent to the high precision motion. For example, a faster motion of the low precision motion may be adjusted to be equivalent to a slower motion of the high precision motion.

In one embodiment, the command is detected 540 in response to the direction of the combined motion 235. For example, a high to low motion of an object such as a hand object may be detected as a command to close an active data object. Similarly, a low to high motion of the object may be detected is a command to open the selected data object.

The command may be detected 540 in response to the palm orientation 225 for the hand object. For example, a palm orientation 225 that rotates right to left may be detected as a paging forward command. Similarly, a palm orientation 225 that rotates from high to low may be detected 540 as a close active file command.

In one embodiment, the command is detected 540 in response to the combined motion 235 and the palm orientation 225. For example, a combined motion 235 of a hand object towards a display with the palm orientation 225 normal to the display may be detected 540 as an activate command. However, a combined motion 235 of the hand object towards the display with the palm orientation 225 perpendicular to the display may be detected 540 as a cut command.

The command may be detected 540 in response to the finger model 230. For example, a left to right rotation of the finger model 230 may be detected 540 as a page back command. Alternatively, a high to low motion of an index finger of the finger model 230 may be detected 540 as an activate command.

In one embodiment, the command is detected 540 in response to the combined motion 235 and the finger model 230. For example, a motion of the hand object with the finger model 230 indicating an open hand may be detected 540 as a move data object command, while a similar motion of the hand object with the finger model 230 indicating a closed hand may be detected 540 as a remove data object command.

The command may be detected 540 in response to the combined motion 235, the palm orientation 225, and the finger model 230. For example, a combined motion of a hand object toward a display with the palm orientation 225 toward the display and an index finger of the hand model 230 extended may be detected 540 as an activate command.

By combining the low precision motion of the low precision image 265 from the low precision lens 105 with the high precision motion from the high precision image 263 of the high precision lens 110 into the combined motion 235, the embodiments may detect a combined motion 235 that embodies a command over the wide field of view of the low precision boundary angle 125. As a result, the embodiments may detect the command within a much larger field of view without the expense of a high precision wide-angle lens.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a camera;
a low precision lens that directs light between a high precision boundary angle and a low precision boundary angle to the camera to form a low precision image;
a high precision lens that directs light within the high precision boundary angle to the camera to form a high precision image;
a processor;
a communication channel coupling the camera and the processor;
a memory that stores code executable by the processor, the code comprising:
code that combines a low precision motion of the low precision image with a high precision motion of the high precision image to form a combined motion; and
code that detects a command from the combined motion.

2. The apparatus of claim 1, wherein the high precision lens is embedded within the low precision lens.

3. The apparatus of claim 1, the code further comprising code that concatenates the low precision image and the high precision image at the high precision boundary angle to form a concatenated image.

4. The apparatus of claim 3, the code further comprising code that detects one of a palm orientation and a finger model from the concatenated image.

5. The apparatus of claim 1, wherein the low precision image comprises a radial distortion.

6. The apparatus of claim 1, the code further comprising code that scales the low precision motion.

7. The apparatus of claim 1, wherein the command is detected in response to a direction of the combined motion.

8. The apparatus of claim 1, wherein the high precision boundary angle and the low precision boundary angle vary as a function of a view angle.

9. The apparatus of claim 1, wherein the high precision lens and the low precision lens are each selected from the group consisting of a fresnel lens, a multi-faceted lens, a compound lens, a bifocal lens, and a micro lens.

10. A method comprising:
combining, by use of a processor, a low precision motion of a low precision image with a high precision motion of a high precision image to form a combined motion; and
detecting a command from the combined motion.

11. The method of claim 10, wherein:
a low precision lens directs light between a high precision boundary angle and a low precision boundary angle to a camera to form the low precision image; and
a high precision lens directs light within the high precision boundary angle to the camera to form the high precision image.

12. The method of claim 11, wherein the high precision lens is embedded within the low precision lens.

13. The method of claim 11, the method further concatenating the low precision image and the high precision image at the high precision boundary angle to form a concatenated image.

14. The method of claim 13, the method further detecting one of a palm orientation and a finger model from the concatenated image.

15. The method of claim 10, wherein the low precision image comprises a radial distortion.

16. The method of claim 10, the method further scaling the low precision motion.

17. A program product comprising a computer readable storage medium that stores code executable by a processor to perform:
combining a low precision motion of a low precision image with a high precision motion of a high precision image to form a combined motion; and
detecting a command from the combined motion.

18. The program product of claim 17, wherein:
a low precision lens directs light between a high precision boundary angle and a low precision boundary angle to a camera to form the low precision image; and
a high precision lens directs light within the high precision boundary angle to the camera to form the high precision image.

19. The program product of claim 17, the code further scaling the low precision motion.

20. The program product of claim 17, wherein the command is detected in response to a direction of the combined motion.
